(19) United States
(12) Patent Application Publication
(10) Pub. No.: US 2004/0035953 A1
(43) Pub. Date: Feb. 26, 2004

(54) Helical coil spray nozzle

(76) Inventors: Earl H. Nelson, West Haven, UT (US); David W. Lindsey, Farr West, UT (US)

Correspondence Address: Sally J. Brown, Autoliv ASP, Inc., 3350 Airport Road, Ogden, UT, 84405, US

(21) Appl. No.: 10/214,956

(22) Filed: Aug. 8, 2002

(51) Int. Cl. B05B 1/26

(52) U.S. Cl. 239/501; 239/500; 239/461

(57) ABSTRACT

A spray nozzle having a helical coil of flat wire is disclosed. The flat wire defines a deflecting surface for distributing a sprayable material in a desired spray pattern. The flat wire also forms an attachment member for connecting the spray nozzle to a coupling member. The coupling member allows the spray nozzle to be attached to a sprayable material source. The spray nozzle may be manufactured by wrapping the flat wire around a conical shaping form to define a helical coil and an attachment member.

### BACKGROUND OF THE INVENTION

1. Field of the Invention

The present invention relates to spray nozzles. More specifically, the present invention relates to spray nozzles comprised of wire shaped into a helical coil.

2. Description of Related Art

Spray nozzles have widespread uses throughout various industries. Spray nozzles may be employed to extinguish fires, apply paint, wash cars, as well as many other uses. One type of spray nozzle that provides desirable spray characteristics is a single piece spiral shaped spray nozzle. The single piece spiral shaped spray nozzle is a generally conical shaped nozzle machined out from a single piece of material. The nozzle is generally manufactured by machining a spiral shaped slot in a block of material, such that the nozzle appears similar to a tapered screw having a hollow tapered center section. Alternatively, the spiral shaped spray nozzle may also be manufactured through an injection molding or die casting process.

The spiral shaped nozzle operates by directing a stream of liquid through the tapered center section of the nozzle. As the stream of liquid is forced through the tapered center section, an amount of the liquid is segregated out of the center section by impacting each of the tapered edges of the spiral slot in the nozzle. Upon impacting the tapered edges in the tapered center section, the segregated liquid atomizes into a fine mist. By employing a tapered center section, small amounts of the liquid stream will be atomized as the liquid travels through the central section, until most of the liquid is atomized.

Spiral shaped nozzles provide several advantages compared to other types of spray nozzles. One advantage of the nozzle is its resistance to clogging when spraying paints or other viscous substances. The spray nozzle may have a generally large spiral slot that prevents small amounts of paint or other sprayable materials from building up in the slots. Additionally, because the nozzle is manufactured from a single piece, there are no internal components that may fail. Furthermore, the spiral shaped spray nozzle allows for a high discharge velocity of the sprayable material.

While spiral shaped spray nozzle provides various advantages, there are also some associated disadvantages. As stated above, the spiral shaped spray nozzle is typically machined out of a solid piece of material. Machining a complex three-dimensional object, such as the spiral shaped nozzle, from a solid piece of material requires a three axis mill or a multi-dimensional lathe. Three axis mills and multi-dimensional lathers are very expensive pieces of equipment which can be difficult to program and operate. Furthermore, the manufacturing time for machining a spiral shape spray nozzle out of a solid piece of material can be very high, requiring long lead time or a large number of machines in order to produce large batches of the spiral shaped spray nozzles.

Another disadvantage of current spiral shaped spray nozzles is the rigidity created by the manufacturing processes. Generally, machined metals and plastics can be rigid and brittle. If the spray nozzles are struck by an object, there is potential that the nozzle may break. Similarly, an injection molded or die cast spray nozzle may also be brittle. Additionally, machining a nozzle out of a solid piece of material produces a large amount of waste material which can further increase the cost of the nozzle.

Therefore, what is needed in the art is a single piece spray nozzle that may be inexpensively manufactured. What is also needed in the art is a spiral shaped spray nozzle that is partially flexible. What is further needed in the art is spiral shaped spray nozzle that may be rapidly manufactured.

Such an apparatus and process is disclosed herein.

### SUMMARY OF THE INVENTION

The apparatus of the present invention has been developed in response to the present state of the art, and in particular, in response to the problems and needs in the art that have not yet been fully solved by currently available spray nozzles. Thus, it is an overall objective of the present invention to provide a low cost nozzle for distributing a sprayable material.

The present invention is comprised of a low cost spray nozzle made of a helical coil of flat wire defining a central channel. In one embodiment, the central channel has a conical shape. The flat wire includes at least one deflecting surface for distributing a sprayable material in a selected pattern. The deflecting surfaces are configured to segregate away an amounts of sprayable material flowing through the central channel. The flat wire may also be formed into an attachment member for coupling the spray nozzle to a sprayable material source.

The flat wire may be any type of material that is capable of being deflected into a helical coil. Metals, plastics, and composites, are among the possible flat wire materials that may be used for the spray nozzle. However, some materials may require heating in order to deflect the material into a helical coil. The flat wire may also include square or rectangular cross-sectional shapes. Yet other variations of flat wire may include polygonal or curvilinear cross-sectional shapes.

The spray nozzle may be attached to a coupling member by the attachment member. The coupling member provides a union for the flat wire spray nozzle to attach to a hose, pipe, or other sprayable material source. The spray nozzle may be wrapped directly onto the coupling member. Alternatively, the spray nozzle may be attached to the coupling member after it is wrapped. The attachment of the spray nozzle to the coupling member may be further secured by welding or adhering a portion of the spray nozzle to the coupling member.

The spray nozzle also has the advantage of providing a low cost process for manufacturing the spray nozzle. The process includes first providing a bendable flat wire having a selected cross-sectional shape. The cross-sectional shape of the wire will depend upon the shape and function of the deflecting surface. The wire is then wrapped around a shaping form to form a helical coil. The shaping form may have a conical shape or have various steps to control the shape of the helical coil. Finally, the helical coil spray nozzle is removed from the shaping form and the attachment member is attached to the coupling member.

These and other features and advantages of the present invention will become more fully apparent from the following description and appended claims, or may be learned by the practice of the invention as set forth hereinafter.

### BRIEF DESCRIPTION OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a side perspective view of a spray nozzle according to one embodiment of the invention.

FIG. 2 is a partial cross-sectional side perspective view of a spray nozzle attached to a coupling member according to another embodiment of the invention.

FIG. 3 is a perspective view illustrating a process for manufacturing a spray nozzle.

FIG. 4 is a side perspective view of one embodiment of a shaping form.

### DETAILED DESCRIPTION OF THE PREFERRED EMBODIMENTS

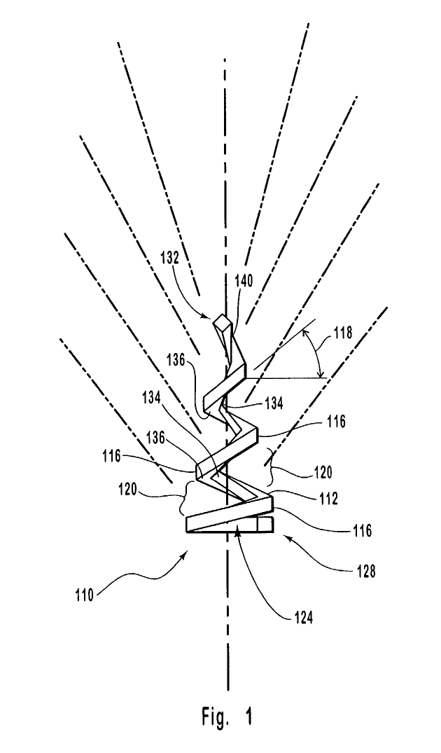

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in FIGS. 1 through 4, is not intended to limit the scope of the invention, as claimed, but is merely representative of presently preferred embodiments of the invention.

The present invention provides for a spray nozzle for distributing a liquid or powder sprayable material. The spray nozzle is made of a low-cost flat wire that is shaped into a helical coil. The helical coil defines a central channel that communicates the sprayable material. The central channel may be conically shaped, such that the flat wire tapers down to define a decreasing diameter within the central channel. As a stream of sprayable material passes through the central channel, the tapered edges of the flat wire segregate away amounts of the sprayable material. The impact of the sprayable material onto the tapered edges of the flat wire causes the segregated amounts of sprayable material to become atomized and propelled out of the spray nozzle in a spray pattern.

The spray nozzle of the present invention may also employ a simple and cost effective manufacturing process. The process may include wrapping the flat wire around a conical shaping form to create a helical coil. The wire may also be wrapped to form an attachment member to allow the helical coil to be attached to a coupling member of a sprayable material source. The process of wrapping a flat wire around a shaping form provides significant cost advantages over machining a spray nozzle with three axis mill or injection molding the spray nozzle. Also, the present process does not waste a large amount of material nor does it require expensive machinery and tooling. Thus, the helical coil spray nozzle may be manufactured at a much reduced cost over that of conventional machined spray nozzles.

Referring now to FIG. 1, a side perspective view of a spray nozzle 110 is illustrated. The spray nozzle 110 is comprised of a helical coil of flat wire 112. A helical coil may be a generally spiral shaped member defined by a single elongated member wrapped around and along the length of a single axis, where the axis need not necessarily be straight. The distance between the axis of the helix and the flat wire 112 will define the general shape of the spray nozzle 110. For example, the spray nozzle 110 may be conical, cylindrical, or various other shapes. The helical coil defines a plurality of tiers 116 in the spray nozzle 110 that are determined by the wrap angle 118 of the flat wire 112. The spaces between the tiers 116 define openings 120 in the spray nozzle 110 from which the sprayable material may eject. The openings 120 are in fact a single slot wrapping around the spray nozzle 110 that functions as multiple slots when viewing the spray nozzle 110 from a side.

The flat wire 112 may have various configurations depending upon the embodiment of the spray nozzle employed. Generally, the flat wire 112 may be any type of material capable of defining a helical coil. The flat wire 112 may be a metal, plastic, composite, or other similar material. Some materials may require heating in order to deflect the material into a helical coil, such a plastic material.

A flat wire 112 may be a generally long strand of material having a substantial cross-sectional shape. The cross-sectional shape of the flat wire 112 should be substantial enough to maintain the helical shape of the spray nozzle 110. The flat wire 112 should also have substantial cross-sectional shape to employ at least one flat surface for atomizing a sprayable material. The cross-sectional shape of the flat wire 112 is not limited to a rectangular cross-sectional shape. The cross-sectional shape may include various polygonal shapes such as triangular, rectangular, pentagonal, etc. Generally, as used herein, polygon references are any cross-sectional shaped bounded by three or more line segments, where at least one line segment has a generally flat surface. Additionally, two or more line segments of the polygonal cross-sectional shape may be replaced with one or more curvilinear segment and remain within the scope of “polygonal,” as used herein.

The flat wire 112 may be provided in various forms. For example, the flat wire 112 may be provided in a large generally malleable spool. Alternatively, the flat wire 112 may be in the form of a generally straight and rigid rod that is bendable into a helical coil. Furthermore, the flat wire may have various thicknesses. The thicknesses of the flat wire 112 will control in part the malleability of the flat wire 112 and the rigidity of the spray nozzle 110.

Flat wire 112 made of flexible materials may be employed to produce a flexible spray nozzle 110. For example, if the flat wire 112 is a malleable metal, the helical coil spray nozzle will be partially flexible. A flexible spray nozzle 110 has the benefit of being capable of receiving an impact force and not failing. A flexible spray nozzle 110 may be beneficial in applications where the possibility exists that the spray nozzle 110 may be struck by an object. For example, a spray nozzle 100 on a portable device such a fire extinguisher may impact a wall or other surface while extinguishing a fire. In another example, a spray nozzle employed in a production line painting process may be impacted by a misaligned production object being painted or by the operator striking the spray nozzle with a tool.

The helical coil of flat wire 112 defines a central channel 124 in the spray nozzle 110. The central channel 124 provides a channel to communicate a sprayable material through the spray nozzle 110. The sprayable material may be a liquid or powder, such as paint or fire retardant. The shape of the central channel 124 may, depend upon the general shape of the spray nozzle 110. Generally, a conical shaped spray nozzle 110 will have a conical shaped central channel 124. However, if the cross-sectional shape and size of the flat wire 112 is not constant along the helical length of the spray nozzle 110, the central channel 124 and the spray nozzle 110 may have different shapes.

The central channel 124 is configured to allow the sprayable material to pass from the base 128 of the spray nozzle 110 to the end 132 of the spray nozzle 110. As a stream of sprayable material passes through the central channel 124 toward the end 132, selected amounts of sprayable material are segregated away from the stream of sprayable material. The selected amounts of sprayable material are segregated away from the stream as the sprayable material impacts the tapered edges 134 of the deflecting surfaces 136. Once the sprayable material impacts the deflecting surfaces 136, the sprayable material atomizes and is propelled out of the spray nozzle 110.

The deflecting surface 136 is one or more sides of the flat wire 112 that diverts selected amounts of sprayable material out of the central channel 124. The angle of the deflecting surfaces 136 is partially controlled by the wrap angle 118 of the helical coil. Additionally, the deflecting surface 136 may have a tilt created by the winding orientation of the flat wire 112 and also created by the cross-sectional shape of the flat wire 112. The wrap angle 118 and the tilt of the deflecting surface 136 will partially control the spray pattern of the spray nozzle 110. Different variations of spray nozzles 110 may incorporate various wrap angles 118 and tilts of the deflecting surface 136 to obtain a wide variety of spray patterns. Furthermore, the cross-sectional shape of the flat wire 112 may include two or more deflecting surfaces 136 to allow for additional spray variations.

The spray pattern will also depend upon the shape and size of the central channel 124. Generally, it may be preferred that the central channel be a tapered conical shape where the diameter of the central channel 124 decreases from the base 128 to the end 132 of the spray nozzle 110. The decreasing diameter of the central channel 124 causes the outer edges of a stream of sprayable material to impact the deflecting surfaces 136 along the central channel 124. As the stream of sprayable material flows toward the end 132 of the spray nozzle 110, the cross-sectional size of the stream of sprayable material will decrease in a manner corresponding to the decreasing diameter of the central channel 124.

However, not all of the sprayable material may be deflected out of the spray nozzle 110 by the deflecting surfaces 136. A portion of the central channel 124 may extend completely through the spray nozzle 110, creating an end opening 140 in the spray nozzle 110. The end opening 140 allows a selected amount of sprayable material to eject through the end 140 of the spray nozzle 110 without impacting the deflecting surfaces 136. The end opening 140 in the spray nozzle 110 allows the sprayable material to be applied in the direction of the end 132, providing even coverage of the sprayable material ejecting from the spray nozzle 110.

Other embodiments of the spray nozzle 110 may incorporate a deflecting surface 136 that atomize the sprayable material upon exiting the end opening 140. The end 132 may be obstructed by the flat wire 112 being selected into a position that causes the sprayable material to impact a deflecting surface at the end opening 140.

The spray nozzle 110 may be configured to have various spray patterns. The spray pattern of the spray nozzle 110 is controlled by the wrap angle 118 and tilt of the flat wire 112. For example, if the spray nozzle 110 is loosely wrapped, as illustrated in FIG. 1, then the wrap angle 118 of the coil is generally large. A large wrap angle will produce a generally narrow spray pattern, where the sprayable material is generally atomized in the in the direction of the flow of sprayable material entering the spray nozzle 110.

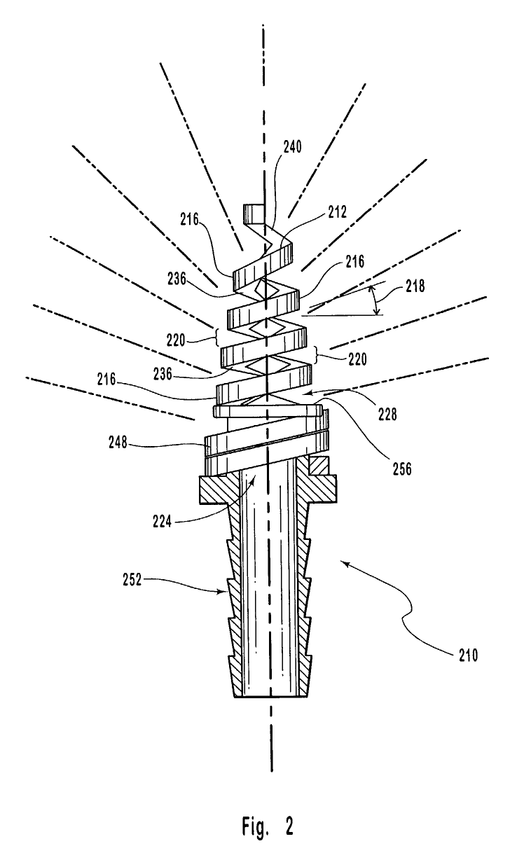

Referring now to FIG. 2, a spray nozzle 210 is illustrated having a generally tightly wrapped helical coil. A tightly wrapped spray nozzle 210 generally has more tiers 216 than would a loosely wrapped spray nozzle with similar heights. By employing a larger number of tiers 216, a tightly wrapped spray nozzle 210 will atomize a finer spray of sprayable material ejecting from the spray nozzle 210. The fine spray of sprayable material is produced by ejecting a sprayable material out of multiple openings 220. Ejecting an amount of sprayable material through multiple openings 220 ejects a smaller quantity of sprayable material per opening 220 than ejecting the same amount of sprayable material through only a few openings 220.

A tightly wrapped spray nozzle 210 will also produce a generally broad spray pattern. The spray pattern of a tightly wrapped spray nozzle 210 will atomize a sprayable material in the in the direction that is generally perpendicular to the flow of sprayable material entering the spray nozzle 210. However, a tightly wrapped spray nozzle 210 will direct some sprayable material in the direction of the flow of sprayable material into the spray nozzle 210.

The spray pattern may be varried by controlling the cross-sectional shape of the flat wire 212 along its length, where a first portion of the flat wire 212 has a first cross-section and the second portion of the flat wire 212 has a second cross-section. For example, the first portion of the flat wire 212 may have a square cross-section and the second portion of the flat wire 212 may have a triangular cross-section. By varying the cross-sectional shape along the length of the flat wire 212, the spray nozzle 210 can be configured to provide varying spray patterns.

The use of flat wire 212 shaped to define a helical coil allows for inexpensive and simple variations of the spray nozzle 210, compared to similar variations in a machined nozzle. The use of flat wire 212 allows the shape of the flat wire 212 to be selected before being wrapped into a spray nozzle 210. Varying the shape of an un-wrapped flat wire 212 is considerably easier then varying the shape of a machined nozzle. Thus, a large number of shapes may be incorporated into the wrapped spray nozzle 210 that are difficult or impossible to achieve in a machined nozzle.

In order to attach the spray nozzle 210 to sprayable material source, the formable flat wire 212 may be bent to define an attachment member 248 at the base 228 of the spray nozzle 210. The attachment member 248 may be a continuation of the helical coil of flat wire 212 that is bent to allow attachment to a coupling member 252. The coupling member 252 is generally configured to allow the spray nozzle 210 to easily attach to conventional tubes, piping, or the like. However, the coupling member 252 may be integrally formed to a tube, pipe, or other similar member.

The shape of the attachment member 248 will depend upon the type of coupling member 252 employed. For example, the attachment member 248 illustrated in FIG. 2, is configured to attach to a coupling member 252 having a flange section 256. The attachment member 248 wraps around an end of the coupling member 252 such that the flange section 256 prevents the attachment member 248 from sliding off the coupling member 252.

The attachment member 248 may be wrapped around the coupling member 252 numerous times, according to strength requirements. For example, the attachment member 248 illustrated in FIG. 2 is wrapped around the coupling member 252 twice. However, in another embodiment an attaching member 248 may be wrapped around the coupling member 252 only once. In yet another embodiment, the attachment member 248 may wrap around the coupling member 252 numerous times.

Furthermore, additional attachment mechanisms may be incorporated in addition to or instead of wrapping the attachment member 248 around the coupling member 252. The attachment member 248 may be welded to the coupling member 252. Alternatively, the attachment member 248 may be adhered to the coupling member 252 through a high strength epoxy or other similar adhesive. Additionally, the coupling member 252 may incorporate multiple variations, such as a coupling member 252 not including a flange section 256.

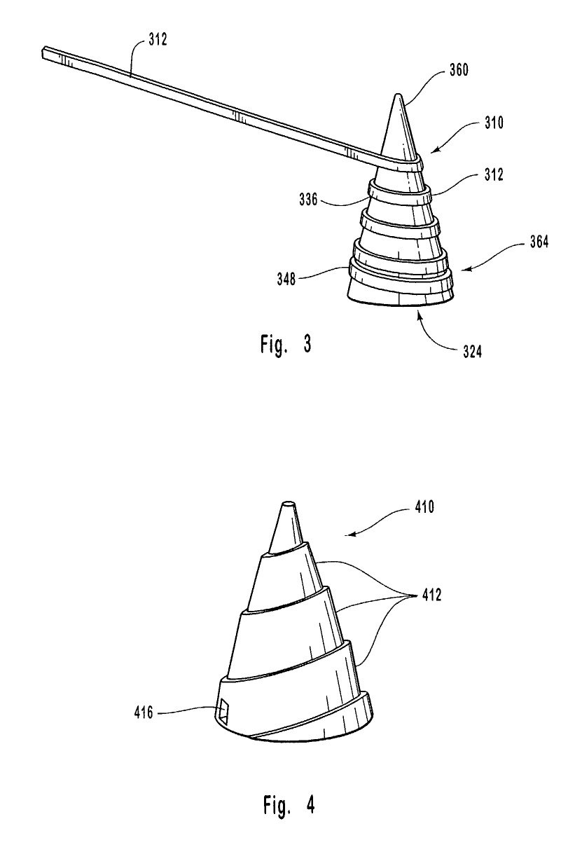

Referring now to FIG. 3, a process for forming a spray nozzle 310 having a helical coil of flat wire 312 and coupling member 352 is illustrated. The present invention provides the advantage of manufacturing a helical spray nozzle 310 from a relatively inexpensive flat wire 312. The flat wire 312 is wrapped around a shaping form 360. The shaping form 360 may be configured to have an outer surface that is generally equal to the desired shape of the spray nozzle 310. The shaping form 360 may be a rigid metal material of sufficient rigidity to bend and shape the flat wire 312 around the shaping form 360.

The spray nozzle 310 may be formed by first attaching an end of the flat wire 312 to the shaping form 360. It may be preferable to attach the flat wire 312 at the base 364 of the shaping form 360. Attachment at the base 364 may be preferable because the base 364, having a larger diameter, allows for more locations to attach the flat wire 312 during the bending process.

Once the flat wire 312 is attached to the shaping form 360, the flat wire 312 may be wrapped around the shaping form 360 according to the design of the spray nozzle 310. In a conical shaped spray nozzle 310, the flat wire 312 will be wrapped around the decreasing diameter of the shaping form 360. Once the spray nozzle 310 is formed the flat wire 312 may be cut and the spray nozzle 310 removed from the shaping form 360.

Finally, the attachment member 248 of the spray nozzle 310 may be attached to a coupling member 252. Where the coupling member 252 employs a flange 256, the spray nozzle 210 may simply screw onto the coupling member 252, as illustrated in FIG. 2. In other embodiments, the flexible flat wire 312 may be flexed to open the diameter of the central channel 224 in order to attach to the coupling member 252. In yet another embodiment, the coupling member 252 may slidably attach to the spray nozzle 210.

Referring again to FIG. 3, it may be desirable for the shaping form 360 to be smaller than the desired central channel 324 size. In bending a thick flat wire 312, the deflecting flat wire maintains a degree of resilience against the deflection. After the flat wire 312 is bent into the desired shape and the deflecting forces removed, the flat wire 312 will tend to spring-back slightly. While the spring-back may be minimal, it may be desirable to employ a shaping form 360 that is slightly smaller than the desired size of the spray nozzle 310, such that the spray nozzle 310 will spring-back into the desired size.

Alternatively, the degree of spring-back may be reduced by stress relieving the flat wire 312 through a heating process. The flat wire 312 may remain in a loaded state, preventing spring-back. While loaded, the flat wire 312 may be heated to temperatures such that the grain boundaries within the metal relax and conform to the shape of the shape and form 360.

Referring now to FIG. 4, various types of shaping forms 410 may be employed in the present process. For example, a shaping form 410 having a conical shape that is defined by a plurality of steps 412 in the shaping form 410. The steps 412 may be employed to control the spacing of the different tiers of the spray nozzle. The steps 412 also help define the orientation of the deflecting surfaces. Additionally, the shaping form 410 may include a mounting opening 416 for fixing one end of the flat wire. Once the flat wire is fixed in the mounting opening 416, the flat wire is wrapped around the individual steps 412 of the shaping form 410.

One having ordinary skill in the art will recognize that various different configurations of the spray nozzle are possible. Generally, the present invention is comprised of a spray nozzle having a flat wire that is wrapped into a helical coil. The flat wire has at least one deflecting surface to distribute a sprayable material in a selected pattern. The flat wire may also be bent to define an attachment member for connecting the helical coil to a coupling member.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

What is claimed and desired to be secured by United States Letters Patent is:

1. A spray nozzle comprising:
a substantially helical coil of wire defining a central channel, wherein the wire has at least one deflecting surface for distributing a sprayable material in a selected pattern, and wherein the wire defines an attachment member.

2. The spray nozzle, as recited in claim 1, wherein the wire has a polygonal cross-section.

3. The spray nozzle, as recited in claim 1, wherein the attachment member is an extension of the substantially helically oriented wire.

4. The spray nozzle, as recited in claim 1, further comprising a coupling member that is connectable to the attachment member.

5. The spray nozzle, as recited in claim 4, wherein the attachment member is welded to the coupling member.

6. The spray nozzle, as recited in claim 4, wherein the attachment member is adhered to the coupling member by an adhesive.

7. The spray nozzle, as recited in claim 4, wherein the coupling member has a flange section for maintaining the connection of the attachment member to the coupling member.

8. The spray nozzle, as recited in claim 1, wherein the helically oriented wire has a wrap angle.

9. The spray nozzle, as recited in claim 1, wherein the wire is metal.

10. The spray nozzle, as recited in claim 1, wherein the spray nozzle is conical.

11. The spray nozzle, as recited in claim 1, wherein the spray nozzle is cylindrical.

12. A spray nozzle comprising:
a substantially helical coil of flexible wire defining a conical central channel, wherein the flexible wire has at least one deflecting surface for distributing a sprayable material in a selected pattern; and
a coupling member for attaching the nozzle to a sprayable material source.

13. The spray nozzle, as recited in claim 12, wherein the wire has a square cross-sectional shape.

14. The spray nozzle, as recited in claim 12, wherein the spray nozzle further comprises an attachment member.

15. The spray nozzle, as recited in claim 14, wherein the attachment member is an extension of the substantially helically oriented wire.

16. The spray nozzle, as recited in claim 14, wherein the attachment member is welded to the coupling member.

17. The spray nozzle, as recited in claim 14, wherein the attachment member is adhered to the coupling member by an adhesive.

18. The spray nozzle, as recited in claim 16, wherein the coupling member has a flange section for maintaining the attachment member to the coupling member.

19. The spray nozzle, as recited in claim 12, wherein the helically oriented flexible wire has a wrap angle.

20. The spray nozzle, as recited in claim 19, wherein the angle of the helically oriented wire is selected according to a desirable spray pattern.

21. The spray nozzle, as recited in claim 12, wherein the wire is metal.

22. The spray nozzle, as recited in claim 12, wherein the sprayable material is a powder.

23. The spray nozzle, as recited in claim 12, wherein the sprayable material is a liquid.

24. A spray nozzle comprising:
a substantially helical coil of flexible flat wire having a conical central channel, wherein the flexible flat wire has at least one deflecting surface for distributing a sprayable material in a selected pattern, and wherein the flexible flat wire is formed to define an attachment member; and
a coupling member, wherein the attachment member is mountable on the coupling member.

25. The spray nozzle, as recited in claim 24, wherein the flexible flat wire has a square cross-sectional shape.

26. The spray nozzle, as recited in claim 24, wherein the attachment member is an extension of the substantially helically oriented wire.

27. The spray nozzle, as recited in claim 24, wherein the coupling member has a flange section for maintaining the attachment member to the coupling member.

28. The spray nozzle, as recited in claim 24, wherein the helically oriented flexible wire has a wrap angle.

29. The spray nozzle, as recited in claim 24, wherein the wire is metal.

30. A process for manufacturing a spray nozzle having a helical coil of flat wire where the flat wire has at least one deflecting surface for distributing a sprayable material, the process comprising:
providing a formable wire having a selected cross-sectional shape; and
bending the formable wire into a helical shape.

31. The process, as recited in claim 30, wherein the formable wire is bent on a shaping form.

32. The process, as recited in claim 31, wherein the shaping form is conical shaped.

33. The process, as recited in claim 31, wherein the shaping form has a plurality of steps.

34. The process, as recited in claim 31, wherein the shaping form is smaller than the spray nozzle.

35. The process, as recited in claim 31, wherein the shaping form has an opening to receive an end of the forming wire to facilitate bending the formable wire into a helical coil.

36. The process, as recited in claim 31, wherein the helical coil spray nozzle is wrapped directly onto a coupling member.

37. The process, as recited in claim 30, wherein the formable wire is bent into a helical shape that is smaller than the desired shape of the spray nozzle.

38. A process for manufacturing a spray nozzle having a helical coil of flat wire where the flat wire has at least one deflecting surface for distributing a sprayable material, the process comprising:
providing a formable wire having a selected cross-sectional shape;
providing a shaping form for defining the shape of the spray nozzle; and
wrapping the formable wire around the shaping form a plurality of rotations to define a helical shape.

39. The process, as recited in claim 38, wherein the shaping form is conical shaped.

40. The process, as recited in claim 38, wherein the shaping form has a plurality of steps.

41. The process, as recited in claim 38, wherein the shaping form is smaller than the spray nozzle.

42. The process, as recited in claim 38, wherein the shaping form has an opening to receive an end of the forming wire to facilitate bending the formable wire into a helical coil.

43. The process, as recited in claim 38, wherein the formable wire is bent into a helical shape that is smaller than the desired shape of the spray nozzle.

44. A spray nozzle comprising:
a helical coil of flat wire formed by wrapping the flat wire around a conical shaping form, wherein the helical coil of wire defines at least one deflecting surface; and
an attachment member wrapped to connect the spray nozzle to a coupling member.

45. The spray nozzle, as recited in claim 44, wherein the flat wire is metal.

46. The spray nozzle, as recited in claim 44, further comprising a coupling member attached to the attachment member.

47. The spray nozzle, as recited in claim 46, wherein the coupling member is attachable to a sprayable material source.
